(19) United States
(12) Patent Application Publication
(10) Pub. No.: US 2014/0122575 A1
(43) Pub. Date: May 1, 2014

(54) TUNNEL COMMUNICATION SYSTEM

(71) Applicant: FUJITSU LIMITED, Kawasaki-shi (JP)

(72) Inventors: Tsukasa OGATA, Kawasaki (JP); Daisuke YAMAKAWA, Zushi (JP); Kazuo TAKAHASHI, Ebina (JP); Mitsuhiro KENMOTSU, Hadano (JP); Tomoko IWATANI, Kawasaki (JP); Kazunari ISHIKAWA, Kawasaki (JP); Noriomi NAKASHIMA, Meguro (JP)

(73) Assignee: FUJITSU LIMITED, Kawasaki-shi (JP)

(21) Appl. No.: 14/050,667

(22) Filed: Oct. 10, 2013

(30) Foreign Application Priority Data
Oct. 29, 2012 (JP) 2012-237801

(51) Int. Cl. H04L 29/06

(52) U.S. Cl. CPC H04L 67/42
USPC 709/203

(57) ABSTRACT

A relay device, which transmits/receives a packet to/from a tunnel communication establishing device located in a first communication area in order to establish tunnel communications between a client located in the first communication area and a server located in a second communication area, includes: a determination unit that determines based on preset threshold value information whether an actual payload part of a reception packet transmitted from the client or the server needs to be embedded; a translation unit that generates dummy payload identification information when it is determined that the actual payload part of the reception packet needs to be embedded, and alternatively sets a dummy payload part including the generated dummy payload identification information and information indicating an embedment-enabled state in place of the actual payload part of the reception packet; and a transmission unit that transmits the packet including the dummy payload part to the establishing device.

### CROSS-REFERENCE TO RELATED APPLICATION

This application is based upon and claims the benefit of priority of the prior Japanese Patent Application No. JP2012-237801, filed on Oct. 29, 2012, the entire contents of which are incorporated herein by reference.

### FIELD

The disclosures made herein relate to a tunnel communication system.

### BACKGROUND

In an environment in which a client device (hereinafter sometimes simply referred to as “client”) acquires data from a server device (hereinafter sometimes simply referred to as “server”) existing in an identical network, there is a case of, for example, desiring to migrate the server to an external network in order to use cloud computing. Such a case is normally handled by changing an Internet protocol (IP) address of the server.

However, the changing of the IP address of the server significantly affects peripheral devices and the like connected to the server, which leads to a problem in that a work load involved in the changing becomes heavy. As a technology for solving this problem, there exists a layer 2 (L2) tunnel.

By newly using an L2 tunnel communication establishing device (hereinafter sometimes referred to as “L2 tunnel termination device”) having a function capable of establishing L2 tunnel communications, it is possible to migrate the server to the external network without changing settings of the client, the server, and the peripheral devices.

The following are related arts to the invention.

[Patent document 1] WO 2005/114926

[Patent document 2] Japanese Patent Laid-Open Publication No. 2005-303766

### SUMMARY

In a tunnel communication system, a packet transmitted/received between a client and a server is transferred to an L2 tunnel communication establishing device on a client side via an L2 switch. Normally, a payload part of the packet has a far larger size than a header part thereof, which may cause transmission/reception of payload data to be burden on a bandwidth between the L2 switch and the L2 tunnel communication establishing device on the client side.

According to an aspect of the disclosures made herein, a relay device, which transmits/receives a packet to/from a tunnel communication establishing device located in a first communication area in order to establish tunnel communications between a client device located in the first communication area and a server device located in a second communication area, includes: a determination unit that determines based on preset threshold value information whether or not an actual payload part of a reception packet transmitted from the client device or the server device needs to be embedded; a translation unit that generates dummy payload identification information when it is determined that the actual payload part of the reception packet needs to be embedded, and alternatively sets a dummy payload part including the generated dummy payload identification information and information indicating an embedment-enabled state in place of the actual payload part of the reception packet; and a transmission unit that transmits the packet including the dummy payload part to the tunnel communication establishing device.

### BRIEF DESCRIPTION OF THE DRAWINGS

FIG. 1 is a block diagram for illustrating a configuration of a tunnel communication system according to an embodiment;

FIG. 2 is a block diagram for illustrating a configuration of an L2 switch according to the embodiment;

FIG. 3 is a diagram for illustrating structures of a payload embedment determination information table and a payload translation information table according to the embodiment;

FIG. 4 is a diagram for illustrating an outline of an operation sequence according to the embodiment;

FIG. 5 is a diagram for illustrating a packet transmission sequence according to the embodiment;

FIG. 6 is a diagram for illustrating a packet reception sequence according to the embodiment;

FIG. 7 is a diagram for illustrating a packet format according to the embodiment;

FIG. 8 is a diagram for illustrating a packet setting example of the packet transmission sequence according to the embodiment;

FIG. 9 is a diagram for illustrating a packet setting example of the packet reception sequence according to the embodiment;

FIG. 10A is a flowchart for illustrating L2 tunneling processing according to the embodiment;

FIG. 10B is a flowchart for illustrating L2 tunneling processing according to the embodiment;

FIG. 10C is a flowchart for illustrating L2 tunneling processing according to the embodiment; and

FIG. 11 is a flowchart for illustrating unnecessary information deleting processing according to the embodiment.

### DESCRIPTION OF EMBODIMENTS

The embodiment of the disclosures made herein will be described below referring to the drawings in detail. The drawings illustrate a preferred embodiment. It should be understood, however, that the embodiment can be implemented by many different embodiments, and is not limited to the embodiment described herein.

[Tunnel Communication System]

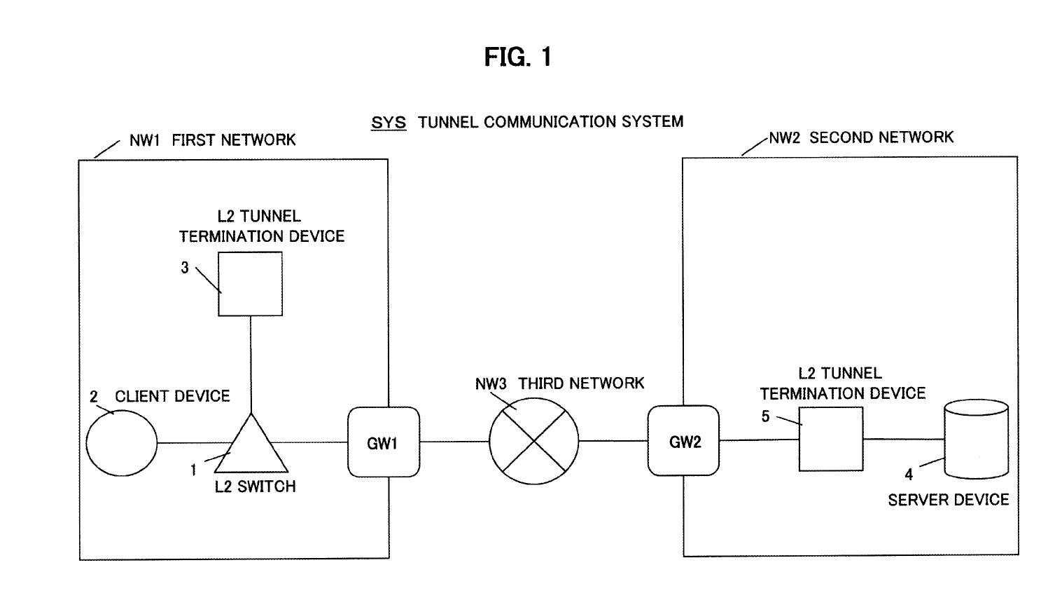

By referring to FIG. 1 illustrating a system configuration according to an embodiment, a tunnel communication system SYS includes a first network NW1 within a first communication area, a second network NW2 within a second communication area, and a third network NW3 within a third communication area.

For example, by using cloud computing, the first network NW1 and the second network NW2, which are physically different networks, become a logically identical network. The third network NW3 connects between the first network NW1 and the second network NW2 through tunneling.

Arranged in the first network NW1 are a layer 2 (L2) switch 1 serving as a relay device, a client device (hereinafter sometimes simply referred to as “client”) 2 such as a personal computer used by a user, an L2 tunnel termination device 3, and a gateway device (hereinafter sometimes simply referred to as “gateway”) GW1. Note that, a plurality of clients 2 are connected to the L2 switch 1, but illustrations thereof are omitted for brevity.

Further, arranged in the second network NW2 are, for example, a server device (hereinafter sometimes simply referred to as “server”) 4 installed in a business place, an L2 tunnel termination device 5, and a gateway device GW2.

Here, payload information (data) on a payload part within a packet is unnecessary for processing for establishing L2 tunnel communications, and hence the L2 switch 1 serving as the relay device changes (substitutes) the payload part of a variable-length packet transmitted to/received from the L2 tunnel termination device 3 on a client 2 side located in the first communication area from an actual payload part to a dummy payload part having a small size (payload length), to thereby reduce a bandwidth.

The L2 tunnel termination device 3 on the client 2 side is an L2 tunnel communication establishing device having a function of setting an L2 tunnel with respect to the L2 tunnel termination device 5 on a server 4 side located in the second communication area via the L2 switch 1 and establishing the L2 tunnel communications by using an encapsulated packet for an L2 tunnel as the packet transmitted/received between the client 2 and the server 4.

Further, the gateway GW1 and the gateway GW2 are devices that perform normal IP routing which does not require a network address translation (NAT) function.

[L2 Switch]

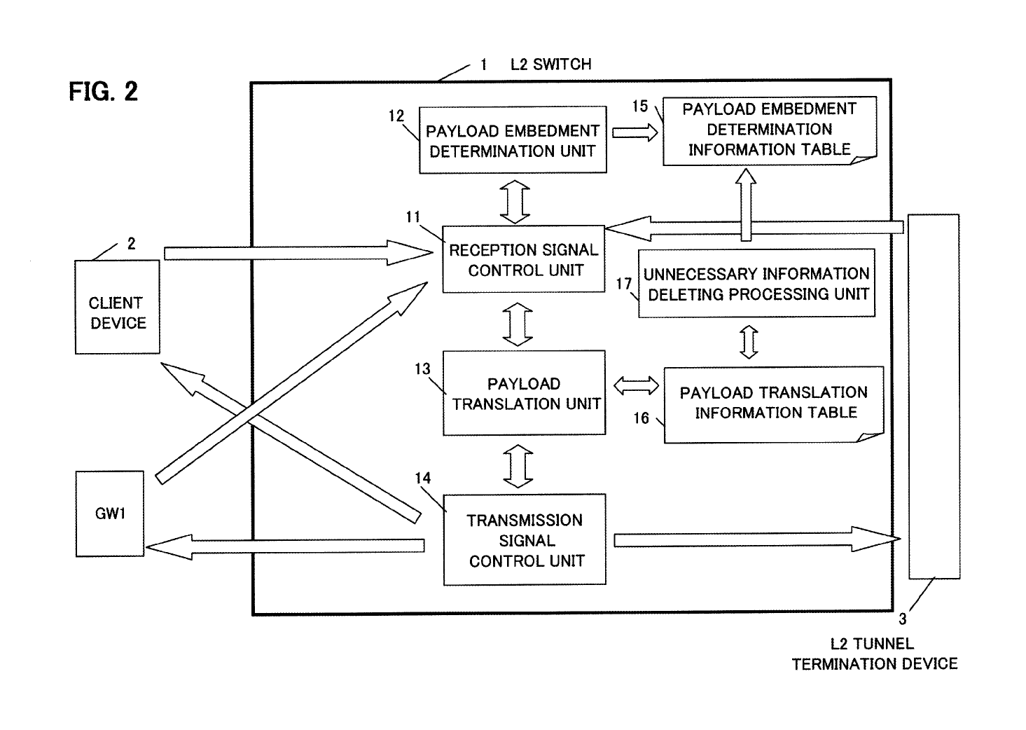

FIG. 2 illustrates a configuration of the L2 switch 1 within the tunnel communication system SYS according to the embodiment illustrated in FIG. 1.

By referring to FIG. 2, the L2 switch 1 serving as the relay device includes the following elements as hardware components. In other words, a central processing unit (CPU) serving as a processor, a random access memory (RAM) serving as a work memory, a read only memory (ROM) that stores a boot program for a startup.

Further, the L2 switch 1 includes a nonvolatile flash memory that stores an operating system (OS), various application programs, and various kinds of information (including data) in a rewritable manner, a communication interface, and the like. Those hardware components can easily be understood and implemented by a person skilled in the art, and hence illustrations thereof are omitted here.

In order to logically realize an L2 tunneling processing function described later in detail, a control program is previously installed in the flash memory within the L2 switch 1 as the application program. Then, in the L2 switch 1, the CPU loads this control program into the RAM and executes the control program in response to a trigger such as reception of the packet from the client 2.

To be further described in detail, the L2 switch 1 includes, as functional components, a reception signal control unit 11, a payload embedment determination unit 12, a payload translation unit 13, and a transmission signal control unit 14.

The reception signal control unit 11 receives a packet from the client 2, the L2 tunnel termination device 3, or the gateway GW1, and issues a processing request to the payload embedment determination unit 12 or the payload translation unit 13.

The payload embedment determination unit 12 determines whether or not to embed the payload part of the packet received from the client 2 or the gateway GW1 based on payload embedment determination information.

The payload translation unit 13 translates the payload part of the packet to be transmitted to the L2 tunnel termination device 3 based on payload translation information as described later in detail. Further, the payload translation unit 13 translates the payload part of the packet received from the L2 tunnel termination device 3, at a time of transmission thereof to the gateway GW1, based on the payload translation information as described later in detail.

The transmission signal control unit 14 transmits the packet to the client 2, the L2 tunnel termination device 3, or the gateway GW1.

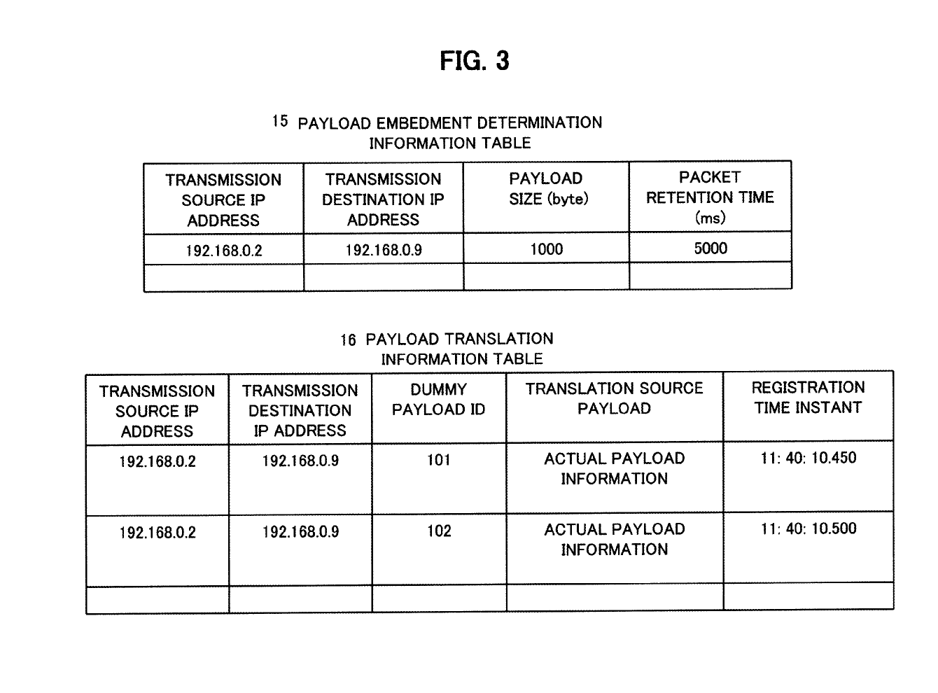

Further, the L2 switch 1 includes, as storage units, a payload embedment determination information table 15 and a payload translation information table 16, and various kinds of information are stored in those tables as illustrated in detail in FIG. 3.

The payload embedment determination information stored in the table 15 is information used for determination as to whether or not to embed the payload part of the packet. The payload embedment determination information is, for example, previously stored in the table 15 by a network operator, and includes a transmission source IP address (here, IP address of the client 2), a transmission destination (destination) IP address (here, IP address of the server 4), a payload size (byte), and a packet retention time (ms).

The payload translation information stored in the table 16 is used as registration information relating to a subject communication, for which the payload part of the packet is embedded, in order to manage a correspondence between dummy payload information and actual payload information. The payload translation information includes the transmission source IP address (here, IP address of the client 2), the transmission destination (destination) IP address (here, IP address of the server 4), dummy payload identification information (ID), the translation source payload, and a registration time instant. The actual payload information on the payload part (actual payload part) within a translation source packet is saved as it is in a translation source payload field within the payload translation information table 16.

The L2 switch 1 that employs the above-mentioned configuration transmits/receives the packet to/from the L2 tunnel termination device 3 located in the first communication area in order to establish tunnel communications between the client 2 located in the first communication area and the server 4 located in the second communication area.

The L2 switch 1 determines based on preset threshold value information whether or not the actual payload part of a reception packet transmitted from the client 2 or the server 4 needs to be embedded. Further, when it is determined that the actual payload part of the reception packet needs to be embedded, the dummy payload identification information is generated, and the dummy payload part including the generated dummy payload identification information and information indicating an embedment-enabled state is alternatively set in place of the actual payload part of the reception packet. Then, the packet including the dummy payload part is transmitted to the L2 tunnel termination device 3.

When it is determined that the actual payload part of the reception packet does not need to be embedded, the L2 switch 1 sets information indicating an embedment-disabled state in the actual payload part of the reception packet, and transmits the packet including the actual payload part, in which the information indicating the embedment-disabled state is set, to the L2 tunnel termination device 3.

In addition, when the information indicating the embedment-enabled state is confirmed in the dummy payload part of the reception packet from the L2 tunnel termination device 3, the L2 switch 1 extracts the dummy payload identification information from the dummy payload part, extracts the actual payload information corresponding to the extracted dummy payload identification information from the payload translation information table 16, and sets only the extracted actual payload information in the actual payload part of the reception packet. Then, the packet including the actual payload part is transmitted to the client 2 or the server 4.

When the information indicating the embedment-disabled state is confirmed in the actual payload part of the reception packet from the L2 tunnel termination device 3, the L2 switch 1 deletes the information indicating the embedment-disabled state from the actual payload part, and transmits the packet including the actual payload part to the client 2 or the server 4.

In addition, in the L2 switch 1, an unnecessary information deleting processing unit 17 serving as another functional component periodically performs processing for determining for the registration information within the payload translation information table 16 whether or not a retention expiry time instant obtained by adding the packet retention time to the registration time instant exceeds a current time instant and deleting the registration information resulting in exceeding the current time instant.

[Operation]

Next, an operation example of the tunnel communication system SYS according to the embodiment illustrated in FIG. 1 is described by also referring to related figures. Note that, intermediation of the third network NW3 is omitted in the following operation description.

(Operation Sequence (Outline))

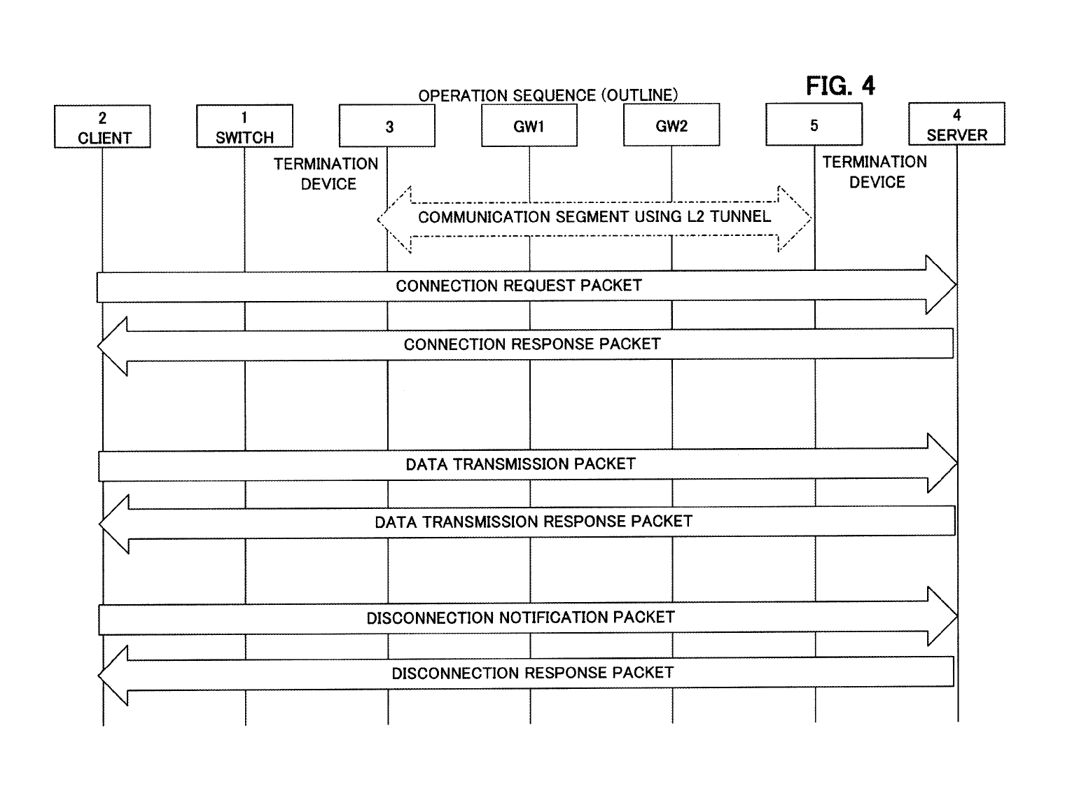

First, by referring to FIG. 4, a description is made of an outline of an operation sequence performed between the client 2 and the server 4 in a case where the L2 tunnel communications are performed in the tunnel communication system SYS.

In this tunnel communication system SYS, a communication segment using the L2 tunnel is defined between the L2 tunnel termination device 3 and the L2 tunnel termination device 5 via the L2 switch 1.

When the client 2 transmits a connection request packet to the server 4, this connection request packet is processed by the L2 switch 1 and the L2 tunnel termination device 3 and then received by the L2 tunnel termination device 5 via the gateway GW1 and the gateway GW2. Then, the connection request packet processed by the L2 tunnel termination device 5 is received by the server 4.

The server 4 that has received the connection request packet transmits a connection response packet to the client 2. This connection response packet is processed by the L2 tunnel termination device 5 and then received by the L2 switch 1 via the gateway GW2 and the gateway GW1. Then, the connection response packet processed by the L2 tunnel termination device 3 is received by the client 2 via the L2 switch 1.

With this configuration, through the intermediation of the L2 switch 1, the L2 tunnel termination device 3, the gateway GW1, the gateway GW2, and the L2 tunnel termination device 5, the client 2 and the server 4 transmit/receive a data transmission packet and a data transmission response packet, and then transmit/receive a disconnection notification packet and a disconnection response packet, to thereby bring the L2 tunnel communications to an end.

(Packet Transmission Sequence)

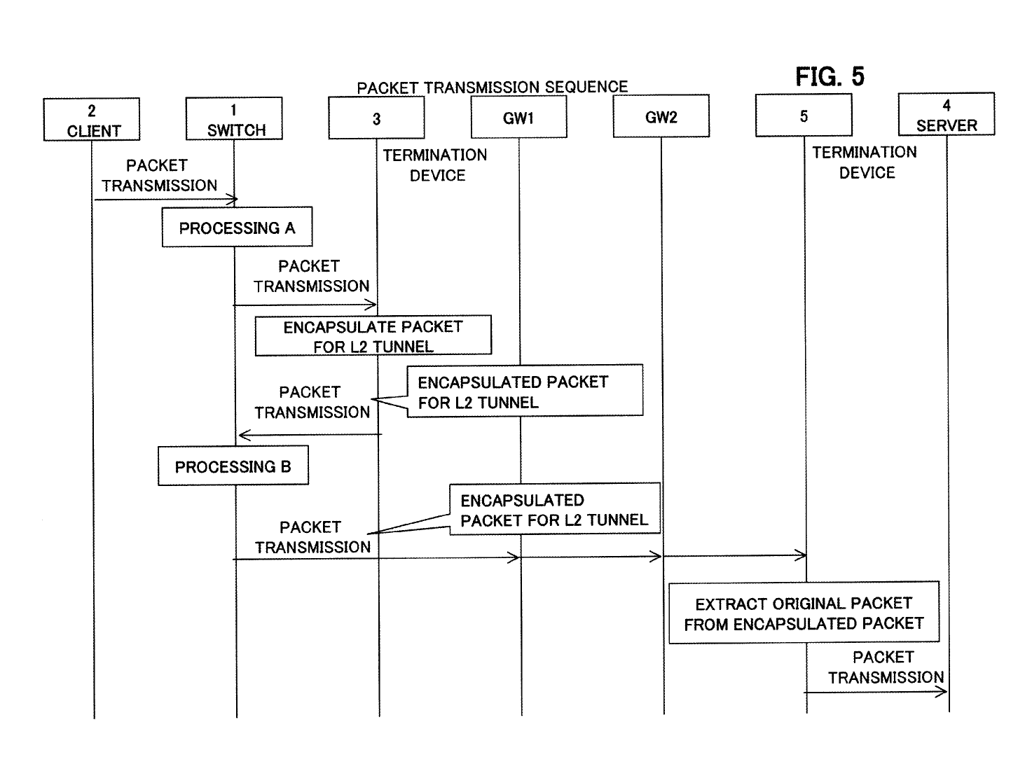

Next, by referring to FIG. 5, a description is made of a packet transmission sequence in which the client 2 transmits the packet to the server 4 in the case where the L2 tunnel communications are performed in the tunnel communication system SYS.

When the client 2 transmits the packet to the server 4 (any one of the connection request packet, the data transmission packet, and the disconnection notification packet described above), this packet is processed by the L2 switch 1.

In other words, the L2 switch 1 performs the following processing A for the packet transmitted from the client 2.
(1) It is determined whether payload embedment is enabled or disabled (necessary or unnecessary) to be carried out.
(2) When the payload embedment is enabled, the payload (actual payload information) is saved, and the dummy payload part is set.
(3) The packet including the dummy payload part is transferred to the L2 tunnel termination device 3.

The L2 tunnel termination device 3 encapsulates the packet for the L2 tunnel, and then transmits the encapsulated packet for the L2 tunnel to the L2 switch 1.

The L2 switch 1 performs the following processing B for the encapsulated packet for the L2 tunnel transmitted from the L2 tunnel termination device 3.
(1) It is determined whether a dummy payload setting for the packet received from the L2 tunnel termination device 3 is present or absent.
(2) When the dummy payload setting is present, the dummy payload part is deleted, and the original payload (actual payload part) is set.
(3) The packet including the actual payload part is transmitted to the L2 tunnel termination device 5.

The encapsulated packet for the L2 tunnel transmitted from the L2 tunnel termination device 3 is received by the L2 tunnel termination device 5 via the gateway GW1 and the gateway GW2.

The L2 tunnel termination device 5 extracts the original packet from the encapsulated packet for the L2 tunnel, and then transmits the original packet to the server 4.

(Packet Reception Sequence)

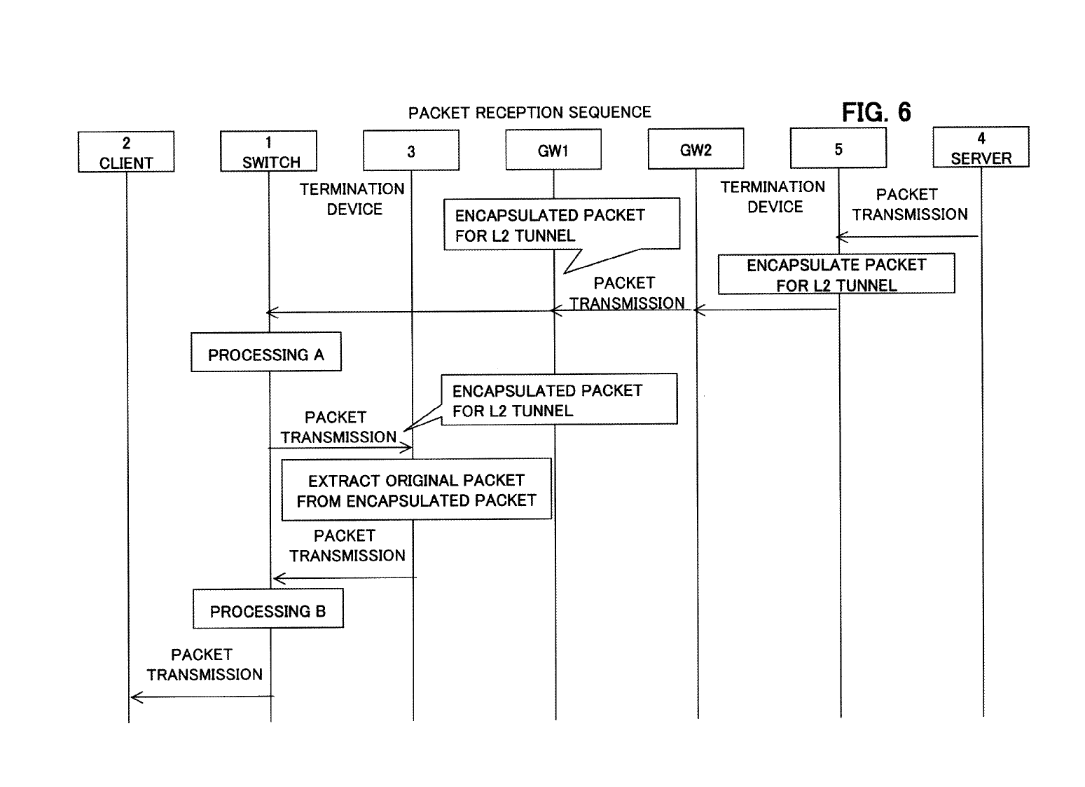

Next, by referring to FIG. 6, a description is made of a packet reception sequence in which the client 2 receives the packet from the server 4 in the case where the L2 tunnel communications are performed in the tunnel communication system SYS.

When the server 4 transmits the packet to the client (any one of the connection response packet, the data transmission response packet, and the disconnection response packet described above), this packet is processed by the L2 tunnel termination device 5.

In other words, the L2 tunnel termination device 5 encapsulates the packet for the L2 tunnel, and then transmits the encapsulated packet for the L2 tunnel to the L2 switch 1 via the gateway GW2 and the gateway GW1.

The L2 switch 1 performs the following processing A for the encapsulated packet for the L2 tunnel transmitted from the L2 tunnel termination device 5.
(1) It is determined whether payload embedment is enabled or disabled to be carried out.
(2) When the payload embedment is enabled, the payload (actual payload information) is saved, and the dummy payload part is set.
(3) The packet including the dummy payload part is transferred to the L2 tunnel termination device 3.

The L2 tunnel termination device 3 extracts the original packet from the encapsulated packet for the L2 tunnel, and then transmits the original packet to the L2 switch 1.

The L2 switch 1 performs the following processing B for the packet transmitted from the L2 tunnel termination device 3.
(1) It is determined whether a dummy payload setting for the packet received from the L2 tunnel termination device 3 is present or absent.

(2) When the dummy payload setting is present, the dummy payload part is deleted, and the original payload (actual payload part) is set.
(3) The packet including the actual payload part is transmitted to the client 2.

(Packet Format and Packet Setting Example)

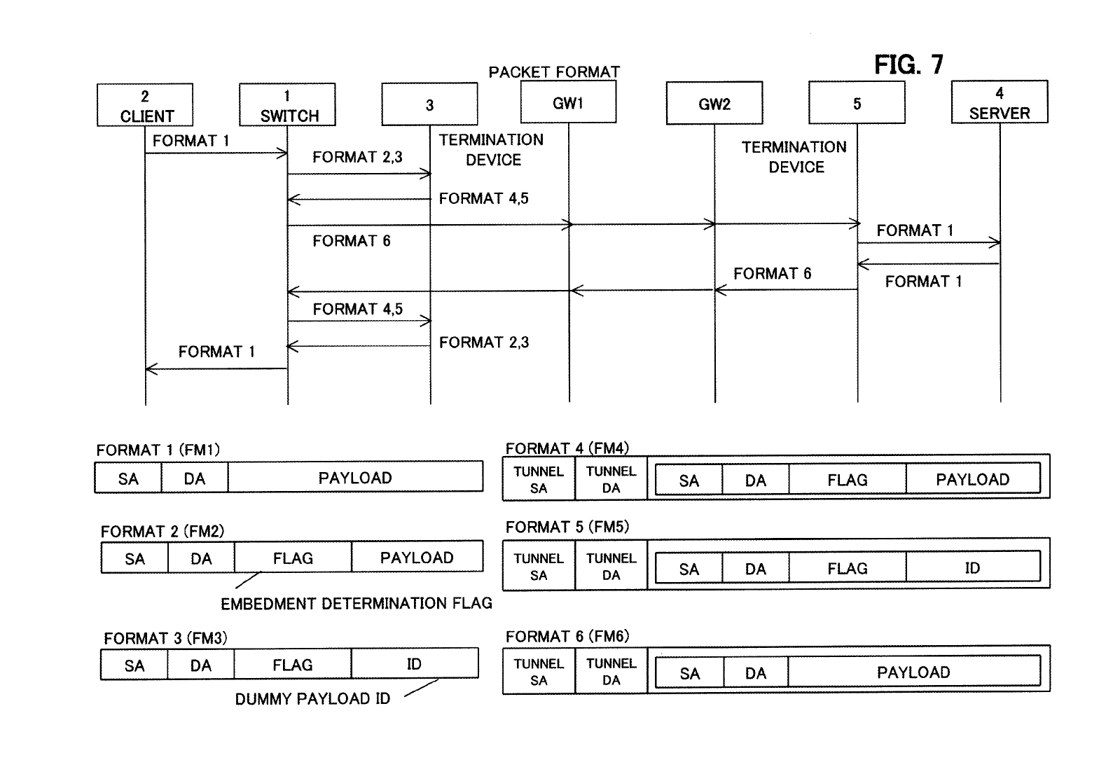

By referring to FIGS. 7, 8, and 9, a description is made of a packet format and a packet setting example in the above-mentioned packet transmission sequence and packet reception sequence.

As understood with reference to FIG. 7, in the above-mentioned packet transmission sequence and packet reception sequence, variable-length packets FM1, FM2, FM3, FM4, FM5, and FM6 corresponding to the following Formats 1, 2, 3, 4, 5, and 6, respectively, are transmitted/received among the client 2, the L2 switch 1, the L2 tunnel termination device 3, the gateway GW1, the gateway GW2, the L2 tunnel termination device 5, and the server 4.

Format 1: transmission source IP address (SA), transmission destination IP address (DA), and payload (actual payload information)

Format 2: transmission source IP address, transmission destination IP address, embedment determination flag, and payload

Format 3: transmission source IP address, transmission destination IP address, embedment determination flag, and dummy payload ID

Format 4: tunnel transmission source IP address, tunnel transmission destination IP address, transmission source IP address, transmission destination IP address, embedment determination flag, and payload

Format 5: tunnel transmission source IP address, tunnel transmission destination IP address, transmission source IP address, transmission destination IP address, embedment determination flag, and dummy payload ID

Format 6: tunnel transmission source IP address, tunnel transmission destination IP address, transmission source IP address, transmission destination IP address, and payload

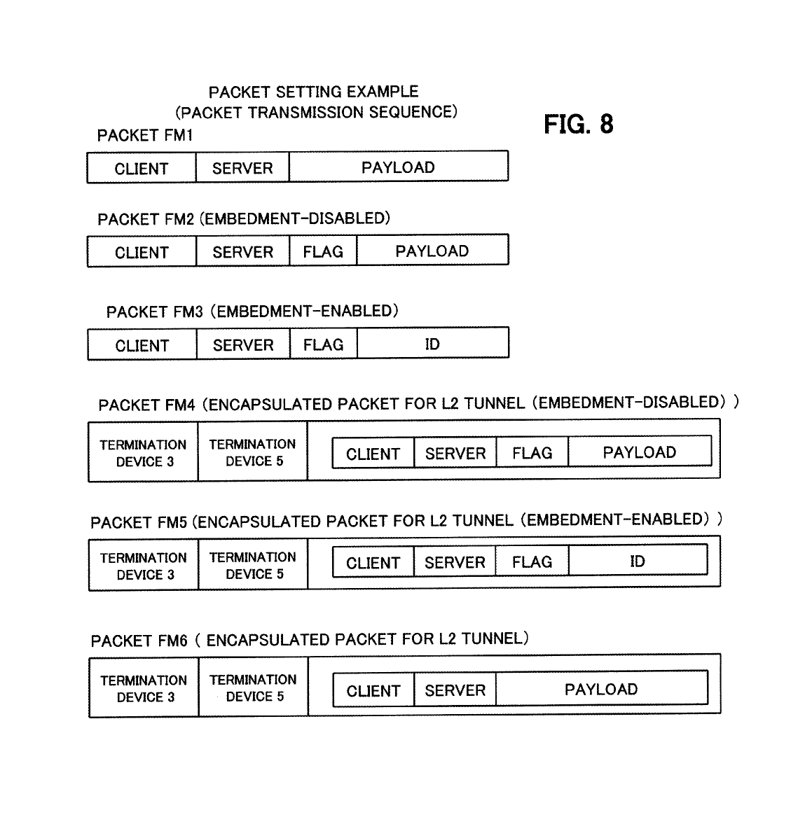

By referring to FIG. 8, in the above-mentioned packet transmission sequence, the variable-length packets FM1, FM2, FM3, FM4, FM5, and FM6 in which specific pieces of information are set as indicated below are transmitted/received among the client 2, the L2 switch 1, the L2 tunnel termination device 3, the gateway GW1, the gateway GW2, the L2 tunnel termination device 5, and the server 4. Here, the packets FM4, FM5, and FM6 are the encapsulated packets for the L2 tunnel. The embedment determination flag is a predefined specific value in order to identify the position of the setting value (embedment-enabled=1 or embedment-disabled=0) of the embedment determination flag in the payload part.

Packet FM1: IP address of client 2, IP address of server 4, and payload (actual payload information)

Packet FM2: IP address of client 2, IP address of server 4, embedment determination flag (embedment-disabled=0), and payload

Packet FM3: IP address of client 2, IP address of server 4, embedment determination flag (embedment-enabled=1), and dummy payload ID

Packet FM4: IP address of L2 tunnel termination device 3, IP address of L2 tunnel termination device 5, IP address of client 2, IP address of server 4, embedment determination flag (embedment-disabled=0), and payload

Packet FM5: IP address of L2 tunnel termination device 3, IP address of L2 tunnel termination device 5, IP address of client 2, IP address of server 4, embedment determination flag (embedment-enabled=1), and dummy payload ID

Packet FM6: IP address of L2 tunnel termination device 3, IP address of L2 tunnel termination device 5, IP address of client 2, IP address of server 4, and payload

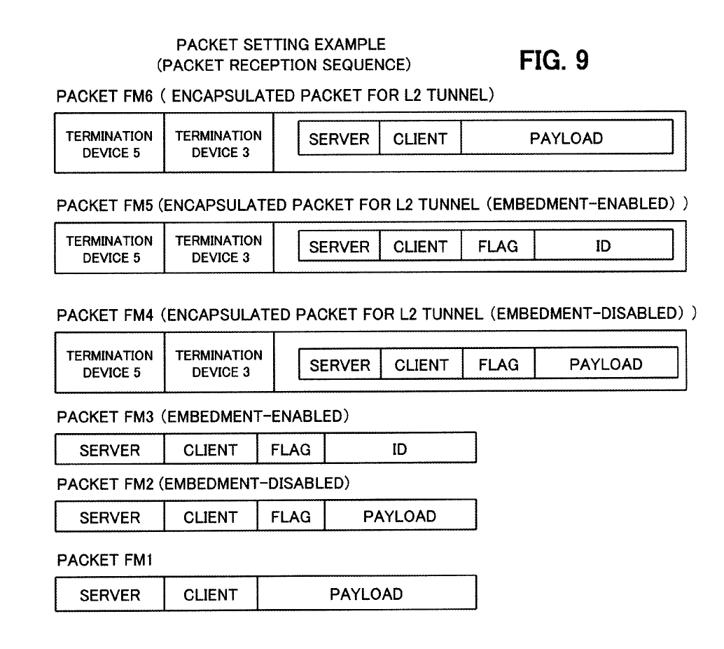

By referring to FIG. 9, in the above-mentioned packet reception sequence, the variable-length packets FM1, FM2, FM3, FM4, FM5, and FM6 in which specific pieces of information are set as indicated below are transmitted/received among the server 4, the L2 tunnel termination device 5, the gateway GW2, the gateway GW1, the L2 switch 1, the L2 tunnel termination device 3, and the client 2. Here, the packets FM4, FM5, and FM6 are the encapsulated packets for the L2 tunnel. The embedment determination flag is a predefined specific value in order to identify the position of the setting value (embedment-enabled=1 or embedment-disabled=0) of the embedment determination flag in the payload part.

Packet FM1: IP address of server 4, IP address of client 2, and payload (actual payload information)

Packet FM2: IP address of server 4, IP address of client 2, embedment determination flag (embedment-disabled=0), and payload

Packet FM3: IP address of server 4, IP address of client 2, embedment determination flag (embedment-enabled=1), and dummy payload ID

Packet FM4: IP address of L2 tunnel termination device 5, IP address of L2 tunnel termination device 3, IP address of server 4, IP address of client 2, embedment determination flag (embedment-disabled=0), and payload

Packet FM5: IP address of L2 tunnel termination device 5, IP address of L2 tunnel termination device 3, IP address of server 4, IP address of client 2, embedment determination flag (embedment-enabled=1), and dummy payload ID

Packet FM6: IP address of L2 tunnel termination device 5, IP address of L2 tunnel termination device 3, IP address of server 4, IP address of client 2, and payload

(L2 Tunneling Processing)

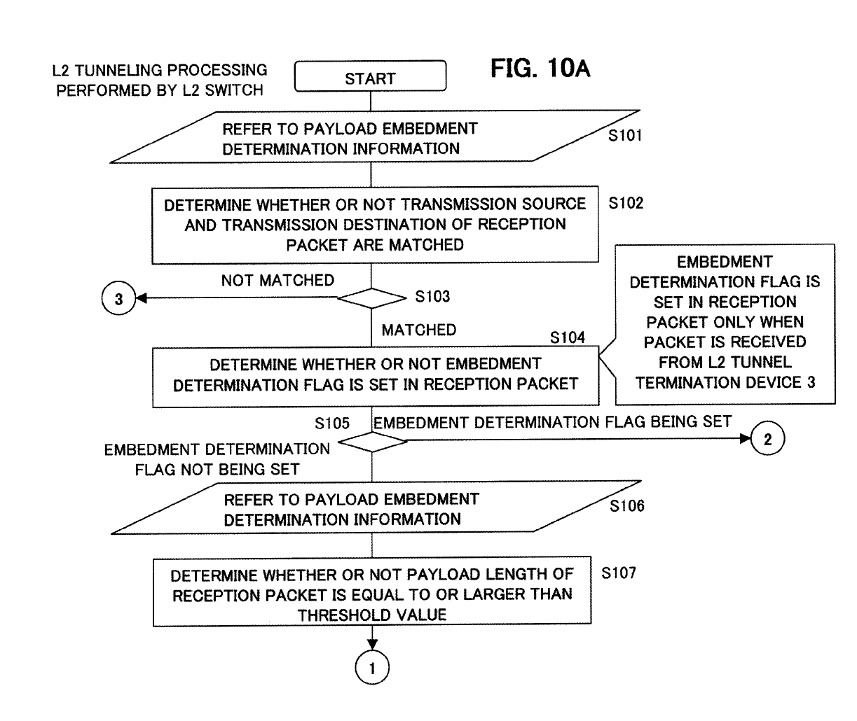

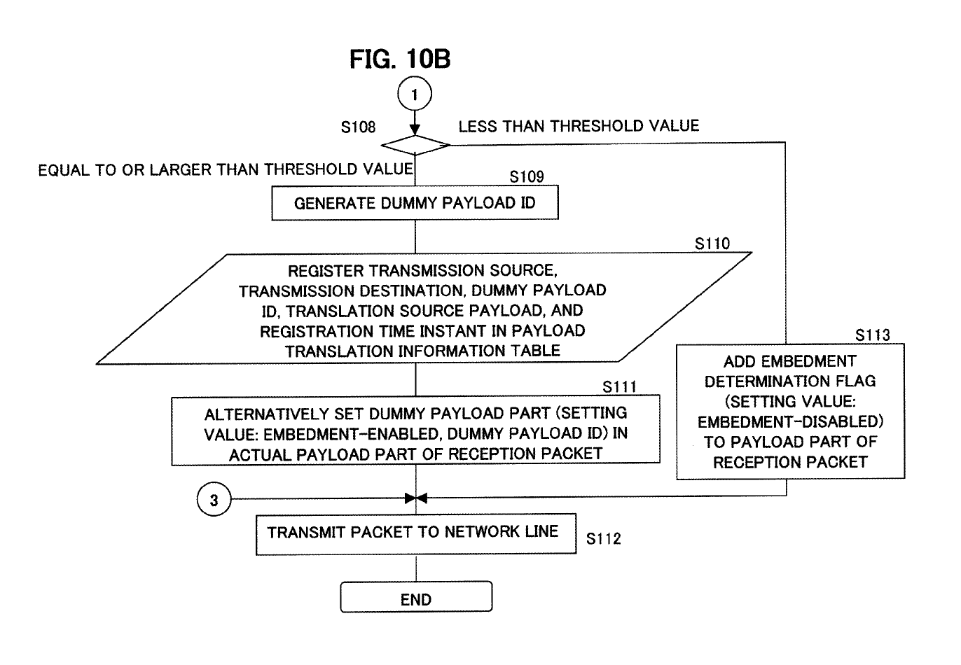

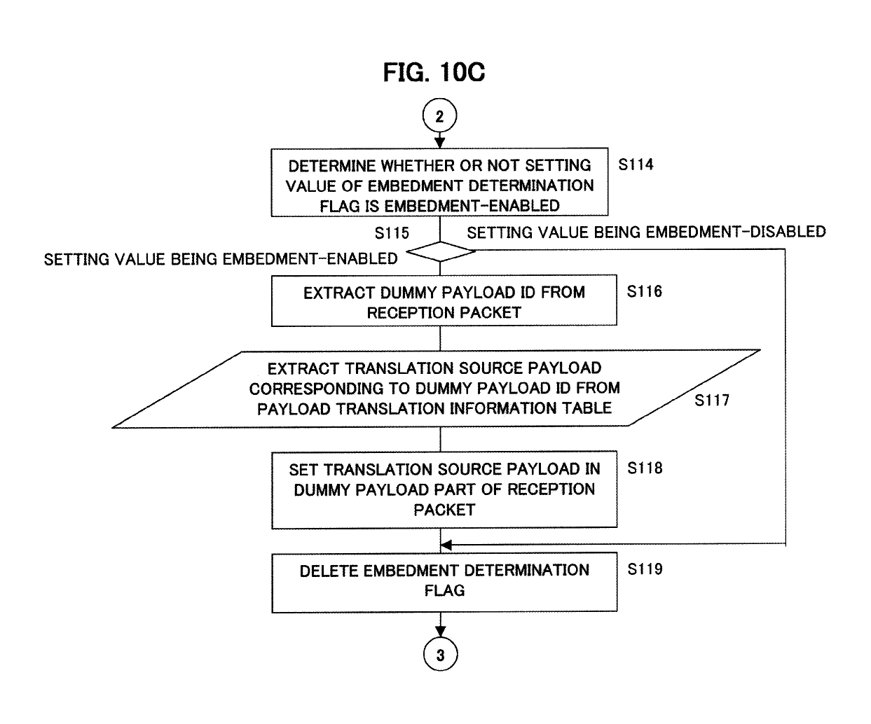

Next, by referring to FIGS. 10A, 10B and 10C, a description is made of packet processing (L2 tunneling processing) performed by the L2 switch 1 in the case where the L2 tunnel communications are performed.

In the L2 switch 1, the CPU loads the control program into the RAM and executes the L2 tunneling processing in response to the trigger such as the reception of the packet from the client 2.

The reception signal control unit 11 transmits the received packet to the payload embedment determination unit 12. The payload embedment determination unit 12 refers to the payload embedment determination information previously stored (registered) in the payload embedment determination information table 15 (see FIG. 3) to determine whether or not corresponding pieces of information within the received packet (strictly speaking, within a header part of the packet), in other words, the transmission source IP address and the transmission destination (destination) IP address are matched. Specifically, it is determined whether or not the transmission source IP address 192.168.0.2 and the transmission destination IP address 192.168.0.9 are both matched (S101 and S102).

If the determination result of the processing of Step S102 is all matched, the payload embedment determination unit 12 determines whether or not the embedment determination flag is set within the reception packet (strictly speaking, within the payload part of the packet) (S103 and S104). Note that, the embedment determination flag is set within the reception packet only when the packet is received from the L2 tunnel termination device 3.

Note that, if the determination result of the processing of Step S102 is not all matched, the payload embedment determination unit 12 notifies the reception signal control unit 11 of an unmatched state (S103). The payload translation unit 13 notified of this unmatched state by the reception signal control unit 11 transmits the reception packet to the transmission signal control unit 14 without performing translation processing due to non-eligibility. When the transmission signal control unit 14 transmits this packet to a network line, the L2 tunneling processing performed by the L2 switch 1 is brought to an end.

If the determination result of the processing of Step S104 is the “embedment determination flag not being set”, the payload embedment determination unit 12 refers to the payload embedment determination information within the payload embedment determination information table 15 to compare the payload size (for example, 1,000 bytes) serving as a threshold value with the payload length of the reception packet. In other words, it is determined whether or not the payload length of the reception packet is equal to or larger than the threshold value (S105, S106, and S107). Note that, it may be determined whether or not the payload length exceeds the threshold value instead of being equal to or larger than the threshold value.

If determining in the processing of Step S107 that the payload length of the reception packet is equal to or larger than the threshold value, the payload embedment determination unit 12 notifies the reception signal control unit 11 of this determination result. The payload translation unit 13 notified of this determination result by the reception signal control unit 11 generates the dummy payload ID (S108 and S109).

The payload translation unit 13 stores, in a free area (record) of the payload translation information table 16 (see FIG. 3), the generated dummy payload ID and a time instant for registration in the table 16 (registration time instant information) along with the transmission source IP address, the transmission destination IP address, and the translation source payload of the information obtained based on the packet received from the reception signal control unit 11 in association with one another (S110).

Here, payload data (actual payload information) on the payload part within the reception packet is saved in the translation source payload field of this table 16 as it is. Further, the dummy payload ID (for example, 101) that can identify the corresponding record and is the dummy payload information having a far smaller size than the actual payload information is stored in a dummy payload ID field of the table 16.

The payload translation unit 13 alternatively sets the dummy payload ID and the embedment determination flag (setting value: embedment-enabled=1) serving as the dummy payload part in the actual payload part of the reception packet in accordance with the packet Format 3 (FM3) illustrated in FIG. 7, and then transmits this packet to the transmission signal control unit 14 (S111).

The transmission signal control unit 14 transmits the packet whose dummy payload part has been alternatively set to the network line (S112). This brings the L2 tunneling processing performed by the L2 switch 1 to an end.

If determining in the processing of Step S107 that the payload length of the reception packet is less than the threshold value, the payload embedment determination unit 12 notifies the reception signal control unit 11 of this determination result (S108). Note that, it may be determined whether or not the payload length is equal to or smaller than the threshold value instead of being less than the threshold value.

The payload translation unit 13 notified of this determination result by the reception signal control unit 11 additionally sets the embedment determination flag (setting value:embedment-disabled=0) in the payload part of the received packet in accordance with the packet Format 2 (FM2) illustrated in FIG. 7, and then transmits this packet to the transmission signal control unit 14 (S113).

Following the processing of Step S113, the transmission signal control unit 14 transmits the packet having the embedment determination flag (embedment-disabled=0) set in the payload to the network line (S112). This brings the L2 tunneling processing performed by the L2 switch 1 to an end.

If the determination result of the processing of Step S104 is the “embedment determination flag being set”, the payload embedment determination unit 12 determines (verifies) whether or not the setting value of the embedment determination flag is “embedment-enabled=1” (S114).

If determining in the processing of Step S114 that the embedment determination flag has the setting value “embedment-enabled=1”, the payload embedment determination unit 12 notifies the reception signal control unit 11 of this determination result. The payload translation unit 13 notified of this determination result by the reception signal control unit 11 extracts the dummy payload ID from the reception packet in accordance with the packet Format 5 (FM5) illustrated in FIG. 7 (S115 and S116).

The payload translation unit 13 extracts the translation source payload corresponding to the extracted dummy payload ID from the payload translation information table 16, and sets the translation source payload in the dummy payload part of the reception packet (S117 and S118).

In addition, the payload translation unit 13 deletes the embedment determination flag (embedment-enabled=1) from the reception packet, and transmits this packet to the transmission signal control unit 14 (S119).

The transmission signal control unit 14 transmits the packet having the actual payload part set to the network line (S112). This brings the L2 tunneling processing performed by the L2 switch 1 to an end.

Note that, if determining in the processing of Step S114 that the setting value of the embedment determination flag is “embedment-disabled=0”, the payload embedment determination unit 12 notifies the reception signal control unit 11 of the determination result. The payload translation unit 13 notified of this determination result by the reception signal control unit 11 deletes the embedment determination flag (embedment-disabled=0) from the reception packet in accordance with the packet Format 4 (FM4) illustrated in FIG. 7, and then transmits this packet to the transmission signal control unit (S119).

The transmission signal control unit 14 transmits the packet brought to a state in which the actual payload part is set to the network line (S112). This brings the L2 tunneling processing performed by the L2 switch 1 to an end.

By executing the above-mentioned L2 tunneling processing, it is possible to reduce transfer traffic regarding the packets transmitted/received between the L2 switch 1 and the L2 tunnel termination device 3.

(Unnecessary Information Deleting Processing)

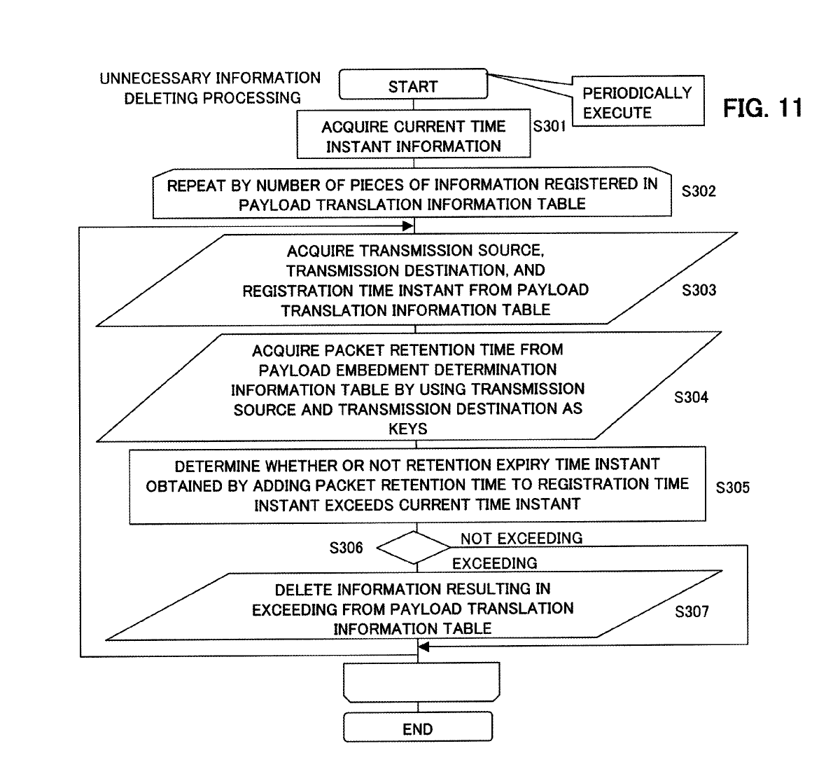

Next, by referring to FIG. 11, a description is made of unnecessary information deleting processing for the payload translation information table 16 (see FIG. 3) carried out with regard to the L2 tunneling processing performed by the above-mentioned L2 switch 1.

This unnecessary information deleting processing is executed by the L2 switch 1 starting up the control program in a predefined cycle. This cycle can be preset by, for example, a network operator.

The unnecessary information deleting processing unit 17 within the L2 switch 1 acquires current time instant information (S301). This current time instant information can be obtained from, for example, the CPU that is measuring time based on total seconds (accumulated seconds).

The unnecessary information deleting processing unit 17 repeatedly executes the subsequent processing of Steps S303 to 5307 by the number of pieces of information (in other words, by the number of records) registered in the payload translation information table 16, and brings the processing to an end when the processing is completed for all the registered pieces of information (S302).

S303: The transmission source IP address, the transmission destination IP address, and the registration time instant corresponding to one record are acquired from the payload translation information table 16.

S304: The packet retention time (for example, 5,000 ms) of the record in which the transmission source IP address and the transmission destination IP address serving as keys are both matched is acquired from the payload embedment determination information table 15.

S305: The retention expiry time instant is calculated by adding the packet retention time acquired in the processing of 304 to the registration time instant (for example, 11:40:10.450) acquired in the processing of Step S303. Then, it is determined whether or not this retention expiry time instant exceeds the current time instant of the information acquired in the processing of Step S301.

S306 and S307: If the determination result of the processing of Step S305 is “exceeding”, the information on the corresponding record is deleted from the payload translation information table 16, to thereby update the payload translation information table 16, and the procedure returns to the processing of 303.

Note that, if the determination result of the processing of Step S305 is “not exceeding”, the procedure returns to the processing of Step S303, and related information corresponding to the next one record is acquired from the payload translation information table 16.

By periodically executing the above-mentioned unnecessary information deleting processing, it is possible to update the payload translation information table 16 to the latest state and maintain the quick L2 tunneling processing.

[Effects]

According to the disclosed relay device, it is possible to reduce transfer traffic regarding the packets transmitted to/received from the tunnel communication establishing device located in the first communication area in order to establish the tunnel communications.

### MODIFIED EXAMPLE

The processing of the embodiment described above is provided as a computer-executable program, and can be provided by a non-transitory computer readable recording medium such as a CD-ROM or a flexible disk or via a communication line.

An arbitrary plurality of or all the processes of the embodiment described above can be selected and combined to be carried out.

What is claimed is:

1. A relay device, which transmits/receives a packet to/from a tunnel communication establishing device located in a first communication area in order to establish tunnel communications between a client device located in the first communication area and a server device located in a second communication area, the relay device comprising:
a determination unit that determines based on preset threshold value information whether or not an actual payload part of a reception packet transmitted from the client device or the server device needs to be embedded;
a translation unit that generates dummy payload identification information when it is determined that the actual payload part of the reception packet needs to be embedded, and alternatively sets a dummy payload part including the generated dummy payload identification information and information indicating an embedment-enabled state in place of the actual payload part of the reception packet; and
a transmission unit that transmits the packet including the dummy payload part to the tunnel communication establishing device.

2. The relay device according to claim 1, wherein:
the translation unit sets, when it is determined that the actual payload part of the reception packet does not need to be embedded, information indicating an embedment-disabled state in the actual payload part of the reception packet; and
the transmission unit transmits the packet including the actual payload part, in which the information indicating the embedment-disabled state is set, to the tunnel communication establishing device.

3. The relay device according to claim 2, further comprising a payload translation information table that stores the dummy payload identification information and actual payload information on the actual payload part of the reception packet in association with each other.

4. The relay device according to claim 3, wherein, when the determination unit confirms the information indicating the embedment-enabled state in the dummy payload part of the reception packet from the tunnel communication establishing device,
the translation unit extracts the dummy payload identification information from the dummy payload part, extracts the actual payload information corresponding to the extracted dummy payload identification information from the payload translation information table, and sets only the extracted actual payload information in the actual payload part of the reception packet, and
the transmission unit transmits the packet including the actual payload part to the client device or the server device.

5. The relay device according to claim 4, wherein, when the determination unit confirms the information indicating the embedment-disabled state in the actual payload part of the reception packet from the tunnel communication establishing device,
the translation unit deletes the information indicating the embedment-disabled state from the actual payload part, and
the transmission unit transmits the packet including the actual payload part to the client device or the server device.

6. The relay device according to claim 3, wherein the payload translation information table stores a transmission source IP address, a transmission destination IP address, and a registration time instant in addition to the dummy payload identification information and the actual payload information on the actual payload part of the reception packet in association with one another.

7. The relay device according to claim 6, wherein:
the preset threshold value information comprises a payload size; and
the relay device further comprises a payload embedment determination information table that previously stores the payload size in association with a packet retention time, a transmission source IP address, and a transmission destination IP address.

8. The relay device according to claim 7, wherein the translation unit periodically performs processing for determining for registration information within the payload translation information table whether or not a retention expiry time instant obtained by adding the packet retention time to the registration time instant exceeds a current time instant and deleting the registration information resulting in exceeding the current time instant.

9. A packet processing method executed by a relay device, which transmits/receives a packet to/from a tunnel communication establishing device located in a first communication area in order to establish tunnel communications between a client device located in the first communication area and a server device located in a second communication area, the method comprising:
determining based on preset threshold value information whether or not an actual payload part of a reception packet transmitted from the client device or the server device needs to be embedded;
generating dummy payload identification information when it is determined that the actual payload part of the reception packet needs to be embedded, and alternatively setting a dummy payload part including the generated dummy payload identification information and information indicating an embedment-enabled state in place of the actual payload part of the reception packet; and
transmitting the packet including the dummy payload part to the tunnel communication establishing device.

10. A non-transitory readable medium recorded with a program that causes a relay device, which transmits/receives a packet to/from a tunnel communication establishing device located in a first communication area in order to establish tunnel communications between a client device located in the first communication area and a server device located in a second communication area, to execute processing comprising:
determining based on preset threshold value information whether or not an actual payload part of a reception packet transmitted from the client device or the server device needs to be embedded;
generating dummy payload identification information when it is determined that the actual payload part of the reception packet needs to be embedded, and alternatively setting a dummy payload part including the generated dummy payload identification information and information indicating an embedment-enabled state in place of the actual payload part of the reception packet; and
transmitting the packet including the dummy payload part to the tunnel communication establishing device.
